(19) United States
(12) Patent Application Publication
(10) Pub. No.: US 2020/0142890 A1
(43) Pub. Date: May 7, 2020

(54) SYSTEM AND METHOD FOR PERFORMING AN INTELLIGENT CROSS-DOMAIN SEARCH

(71) Applicant: SoundHound, Inc., Santa Clara, CA (US)

(72) Inventors: Qindi ZHANG, San Jose, CA (US); Qiaozhi SONG, Los Altos, CA (US)

(73) Assignee: SoundHound, Inc., Santa Clara, CA (US)

(21) Appl. No.: 16/179,843

(22) Filed: Nov. 2, 2018

(51) Int. Cl. G06F 16/2452; G06F 16/248; G06F 16/2457

(52) U.S. Cl. CPC G06F 16/2452; G06F 16/24578; G06F 16/248

(57) ABSTRACT

The technology disclosed relates to performing a cross-lingual search. The cross-lingual search may include receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results and outputting overall results including at least some of the first language results and some of the translated second results.

### FIELD OF TECHNOLOGY

The technology relates to audio and written search queries performed on the internet. In particular, the technology disclosed implements a cross-lingual and/or cross-domain internet search based on a single query directed to a single language or internet domain to provide corresponding search results from that originated in multiple languages and/or internet domains.

### BACKGROUND

The best information available on the internet for a particular search can, often times, be in a different language and/or domain than what is being searched by the user. Many internet users do not know that search results for a query will vary depending upon the language and/or domain in which the search was initiated. Conventionally, internet users initiate a search (e.g., submit a query) in their own native language and/or in an internet domain that corresponds to their current geographic location. Unfortunately, the best results can often be hiding in a language that is different than the initial search language and/or located in a different domain than what the user has the ability or knowledge to be able to search.

For example, a user may perform an internet search for information about “cherry blossoms,” where the search is made using English and is made in an English (U.S.) domain (e.g., search is made on “google.com” for the English words “cherry blossoms”). The results of the search will be dependent upon what is available in English from the English domain. Information regarding “cherry blossoms” that is available in the Japanese language and/or in a Japanese domain will not be provided to the user, despite the fact that there is probably much more information regarding “cherry blossoms” in the Japanese language and/or in a Japanese domain, since cherry blossoms are a celebrated part of Japanese culture.

As another example, typical internet users do not know that results provided by “Wikipedia” are quite different when a user searches “wikipedia.org” (English domain) as compared to “jp.wikipedia.org” (Japanese domain). Specifically, the results from searching “cherry blossoms” in the English language from the English Wikipedia domain are quite different from the results from searching “cherry blossoms” in Japanese from the Japanese Wikipedia domain. The different results from the two different Wikipedia domains are not simply translations of one another. Rather, they contain different information regarding cherry blossoms. In other words, the result from the English domain is not simply a translation of the result from the Japanese domain, or visa-versa. The result from the Japanese domain is more likely to provide greater detail and to be from the perspective of the Japanese culture. The results, depending on the language and domain, will greatly vary and one particular result in a particular language or from a particular domain is likely better than other results from other languages and/or domains. The problem is that the typical internet user does not have the knowledge or the ability to determine how to get the best results from a search, because they do not know how to initiate searches using different languages and from different domains. Typically, users are limited to performing searches in their native language and/or in their default domain.

Therefore, an opportunity arises to develop a technology that can implement cross-lingual and cross-domain searches from a single intuitive interface that provides results in one language that are translated from searches conducted in multiple languages and in multiple domains. The technology disclosed provides such features, which, from the perspective of the user, allows for more efficient, accurate and helpful search results.

### SUMMARY

The technology disclosed addresses the above-described problems by providing a method of performing cross-lingual and/or cross-domain search. The method can include receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results, and presenting integrated overall results including at least some of the first language results and some of the translated second results.

Further, the technology disclosed includes a non-transitory computer-readable recording medium having a computer program for performing a cross-lingual search recorded thereon. When the computer is executed on a computer including a processor and memory, the computer performs a method. The method can include receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results, and presenting integrated overall results including at least some of the first language results and some of the translated second results.

The technology disclosed further includes a system including one or more processors coupled to memory, where the memory is loaded with computer instructions to perform a cross-lingual search. When the computer instructions are executed on the processors they implement actions including receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results, and presenting integrated overall results including at least some of the first language results and some of the translated second results.

Particular aspects of the technology disclosed are described in the claims, specification, and drawings.

### BRIEF DESCRIPTION OF THE DRAWINGS

FIG. 1 illustrates a conventional approach to performing an internet search.

FIG. 2 illustrates an example implementation of the technology disclosed.

FIG. 3 is an example illustration of a process performed by the technology disclosed to implement a cross-lingual and/or cross-domain search.

FIG. 4 illustrates an example environment in which a cross-lingual and/or cross-domain search can be implemented by the technology disclosed.

FIG. 5 is a block diagram of an example computer system that can implement various components of the environment of FIG. 4.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

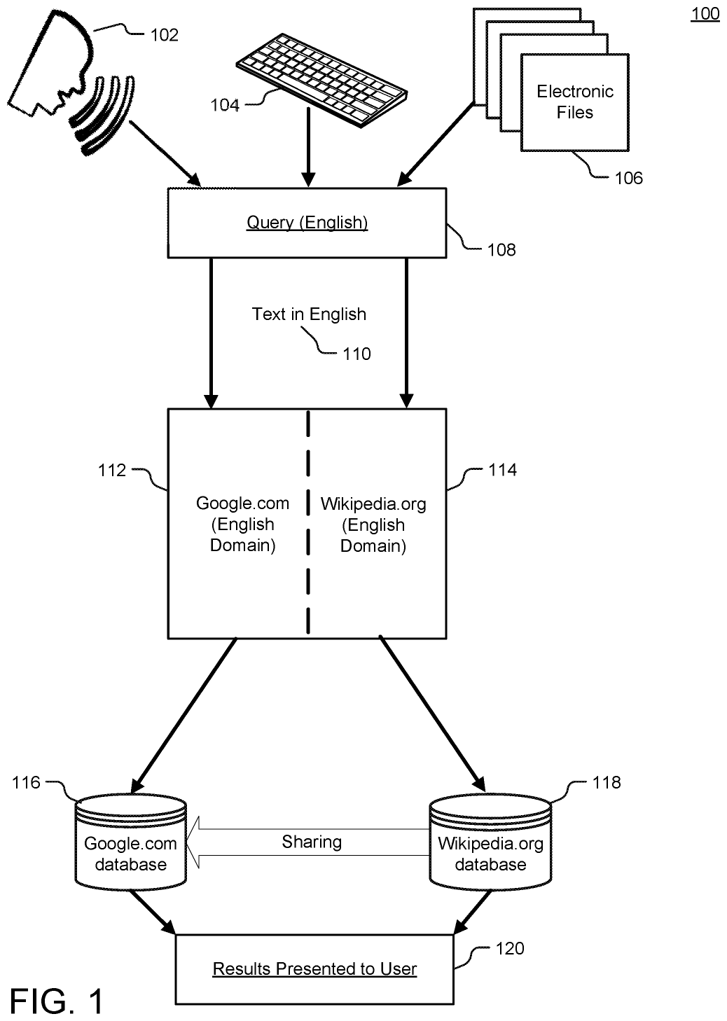

FIG. 1 illustrates a conventional approach 100 to performing an internet search.

In particular, FIG. 1 illustrates that the conventional approach 100 includes receiving a search or query request from one of a speech input 102 from a microphone or some other type of input device, a text input 104 from a keyboard or some other type of text input device or an electronic file or files 106, which can include text compiled from other sources, etc. The information gathered from the speech input 102, the text input 104 or the electronic file or files 106 is then processed to generate a query 108 in, for example, English. In this example, the query 108 is in English because the language spoken by the user in the speech input 102 is English from which an English transcription can be obtained, or because the input text 104 and/or the electronic file or files 106 contain English words.

The query 108, which is either straight text received from the text input 104 or the electronic file or files 106 or a transcription from the speech input 102, is then sent off to the (default) domain of the user. In other words, text in English 110 is provided as a keyword or keywords to a selected domain or a default domain of the user.

For general searches in English, a user's domain might be one of the well-known search engines, such as Google, Bing or Yahoo. In this illustrated conventional approach 100, the text in English 110 is transmitted as the user's search or query to google.com 112 which is an English domain and/or to wikidpedia.org 114, which is also an English domain. Typically, an internet searcher will conduct their first search using a general “catch-all” search engine, such as google.com 112. If the user is not finding the desired results, the user may then transfer over to a more specialized domain, such as wikipedia.org 114. Many more specialized domains that are available are known to a person of ordinary skill in the art of the present application.

For illustrative purposes, this example shows the user's search or query going to both the google.com 112 domain and the wikipedia.org 114 domain. Generally, a user will not simultaneously search two domains. However, as described below, one domain may share information with another domain. The submitted search terms are used by google.com 112 to query a google.com database 116. Similarly, the search terms can be used by wikipedia.org 114 to query a wikipedia.org database 118. It is common for the contents of the wikipedia.org database 118 to be shared with or accessed by the google.com database 116. For example, a search on the google.com 112 domain can provide detailed results from information obtained from both the google.com database 116 and the wikipedia.org database 118. This information is shared by the wikipedia.org database 118 so that the internet searcher can obtain some or all of the matching contents of the wikipedia.org database 118 from the search results provided from the google.com 112 domain. The results are integrated and presented to the user 120 in the form of a summary, where the user can then click-through or select other domains from which the search results originated.

A problem with this conventional approach 100, as mentioned in the BACKGROUND section, is that the best results are not always found in the English language and/or an English domain.

Accordingly, the technology disclosed is capable of performing a cross-lingual and/or a cross-domain search based on a search initiated in a single language and/or in a single domain.

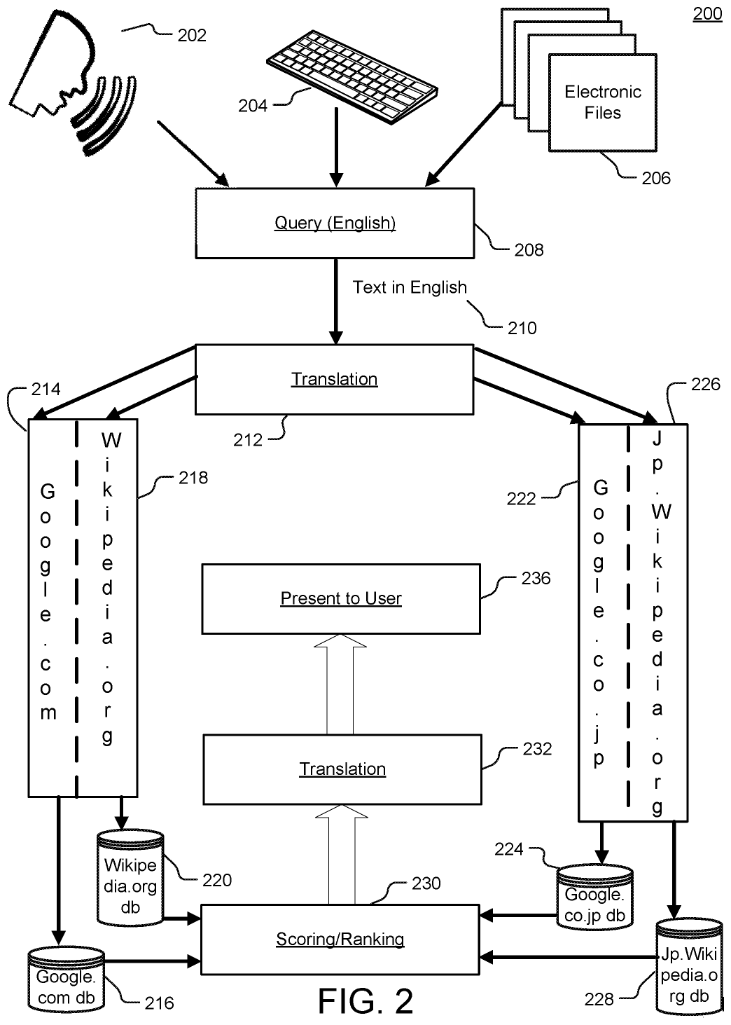

FIG. 2 illustrates an example implementation 200 of the technology disclosed.

Similar to FIG. 1, FIG. 2 illustrates receiving a search or query request from one of a speech input 202 from a microphone or some other type of input device, a text input 204 from a keyboard or some other type of text input device, or an electronic file or files 206, which can include text compiled from other sources, etc. The information gathered from the speech input 202, the text input 204 and the electronic file or files 206 is then processed to generate a query 208 in, for example, English. In this example, the query 208 is in English because the language spoken by the user in the speech input 202 is English from which an English transcription can be obtained, or because the input text 204 and/or the electronic file or files 206 contain English words.

The query 208, which is either straight text received from the text input 204 or the electronic file or files 206 or a transcription from the speech input 202, is then sent off as text in English 210 or, alternatively, as audio, for translation 212. This is where FIG. 2 differs from the single language/domain implementation of FIG. 1. The technology disclosed varies from the conventional approach 100, in that the query 208 in English is translated into at least one other language and is sent to at least one other domain.

Since the initial query 208 is in English, there is no need for a translation 212 to be performed in order for the text in English 210 to be sent to one or more English domains, such as google.com 214 and wikipedia.org 218. These English domains are merely examples of some of the more popular English domains. A single English domain can be used, or multiple English domains can be searched by the technology disclosed. The technology disclosed can be configured to use one or more default domains, which can be pre-selected by the user. Additionally, domains can be automatically selected based on the subject matter of the search and the user can be given the option to add or remove domains. This example implementation 200 includes two English domains. However, just a single English domain can be used, or more than two English domains can be used. Similar to FIG. 1, FIG. 2 illustrates that the search performed using the google.com 214 domain utilizes the google.com database 216 and that the search performed using wikipedia.org 218 utilizes the wikipedia.org database 220.

The translation 212 can translate the text in English 210 to another language such as Japanese. The query 208 is in English is just for example's sake. The query 208 can be in Japanese and then the technology disclosed will translate the text into other languages and search other domains. The languages for translation 212 can be selected by the user at the time of the query, can be previously designated by the user, and/or can be intelligently selected based on the contents of the query. For example, the language or languages to translate into can be identified based on the subject matter of the search, based on past browser history of the user, or the historical use of other applications or programs.

Since, in this example, the query is translated to Japanese, the translated query is used to perform a search on Japanese domains, such as google.co.jp 222 and/or jp.wikipedia.org 226. The search performed using google.co.jp 222 can utilize a google.co.jp database 224 and the search performed using jp.wikipedia.org 226 can utilize a jp.wikipedia.org database 228. Just like the English domains, the jp.wikipedia.org database 228 can share information with the google.co.jp database 224. The technology disclosed is not limited to just the original query language (i.e., English), English domains, the translated query language (i.e., Japanese) and Japanese domains. The original query can be any language combined with any domain or domains and the translated languages can include one or more languages that are different from the original language. The technology disclosed can implement one or more other domains other than the original domains that are used with the original language. The number of languages/domains can be preselected by the user or can be intelligently determined based on an analysis of the original query in the original language. For example, the original query in the original language could include keywords that trigger a high likelihood of relevant results being available in 3 different languages (e.g., Japanese, Chinese and Korean) and corresponding domains. The user can limit the number of alternate languages and/or domains that can be implemented by the technology disclosed.

Once the results are obtained from the corresponding searches performed using the google.com database 216, the wikipedia.org database 220, the google.co.jp database 224 and the jp.wikipedia.org database 228, scoring and ranking 230 can be performed on the results. The scoring and ranking 230 can be performed in many different ways, some of which are described further in detail below. The scoring can be performed based on relevancy of the results or other factors, such as ratings of products being searched (e.g., restaurant dishes, etc.). The results can be scored and ranked individually so that the results from the English domain or domains are scored and ranked separately from the results from the Japanese domain or domains. This way the user is able to differentiate top results from each domain. The results can be scored based on their relevance to a particular topic that can be identified before the search is performed and/or that can be identified based on the results themselves. Alternatively, all of the results can be gathered, scored, ranked, ordered together and then presented to the user in a seamless, integrated manner so that the user does not need to concern themselves as to which languages or domains have been searched. The results can also be scored based on what is trending on other searches, popularity information, personal profile information, location of the user and/or related subject matter, as well as the time of the query. Weighting can also be implemented to assign higher weights to, for example, results that come from a language or domain that is more likely to be relevant (e.g., results for cherry blossoms would have a higher weight if they were in Japanese and/or came from a Japanese domain as opposed to results in Spanish coming from a Spanish domain).

An example of popularity information could be that a query is for the term “president.” When a search is conducted on the Wikipedia domain, a click through rate for the search term “president” is the highest for an article about the U.S. President. This example popularity information indicates that the U.S. President has the highest popularity for the search term “president.” This “high popularity” result can be incorporated into the scoring by giving results that include the current U.S. President a higher score.

The results from the Japanese domain or domains will most likely be in Japanese. Accordingly, a translation 232 is performed on all results that are in a language other than the original query language. The user can also have an option to translate all of the results into a different language (e.g., German) if, for some reason, a different language is preferred. After the translation 232, the results are presented to the user 236. Alternatively, the translation 232 can be performed before the scoring/ranking 230.

The results can be presented to the user 236 in many different forms. For example, if the user is using a speech interface system in a vehicle, then a pre-configured relatively small number of results can be dictated back to the user or presented on a screen of the vehicle. The point is that when using a speech interface system, the user might not be able to easily or safely read all of the results. If the user does not like the initial listing of results, the user can then request the next set of the pre-configured number of results. In contrast, if the user is using a computer, tablet or smart phone, a pre-configured number of results will be provided to the user on their screen. This pre-configured number will probably be much greater than the pre-configured number for the speech interface system. For example, as mentioned above, the results can be separated from each other based on their original language(s) and/or domain(s) (e.g., English language/domain results can be separated from the Japanese language/domain results and then presented based on their scores and rankings).

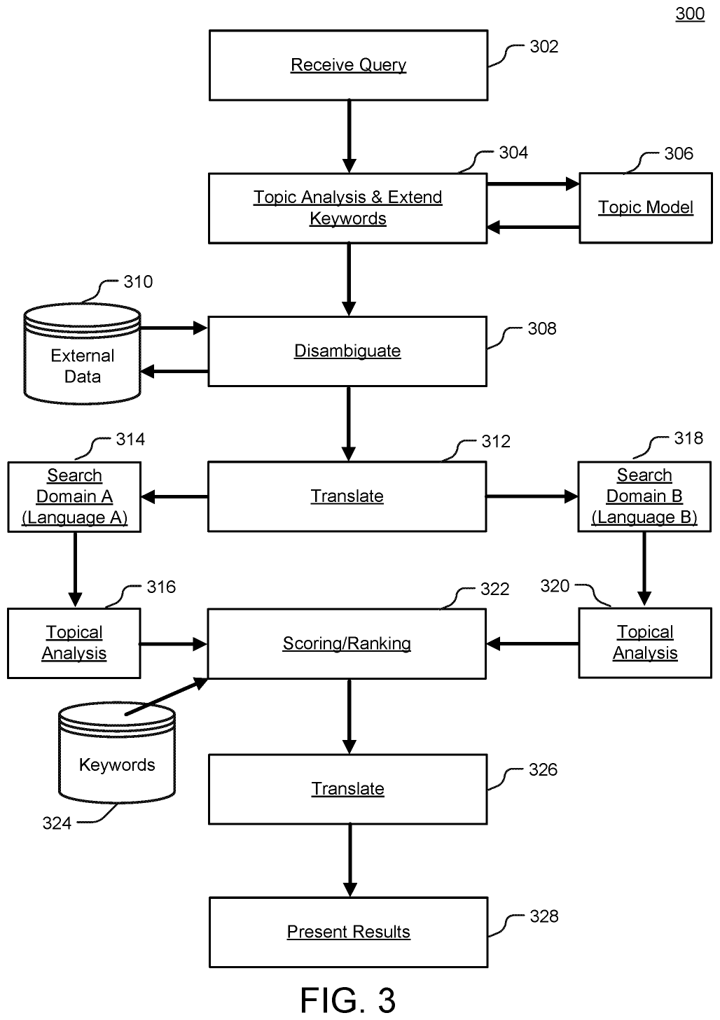

FIG. 3 is an example illustration of a process 300 performed by the technology disclosed to implement a cross-lingual and/or cross-domain search.

Specifically, the process 300 illustrated in FIG. 3 includes receiving the query in operation 302. The receiving of the query is described in more detail above with reference to FIG. 2. The process 300 can also include operation 304, which includes performing an optional topic analysis and extending of keywords. As an example, the implementation illustrated in FIG. 3, will use an original query of “golden week” in English. The query is received in operation 302 and a topic analysis of “golden week” is performed in operation 304. The topic analysis can implement a topic model 306 to assist in determining one or more topics that best align with the phrase “golden week.” Artificial intelligence, such as deep learning and neural networks can be implemented to utilize the topic model 306 to identify one more topics that are related to the query. Alternatively, a word or phrase list can be used to identify topics. Other methods for performing the topic analysis will be clear to those skilled in the art.

Keeping with the “golden week” example, a topic analysis might find that “golden week” refers to a holiday or a week of holidays in both Japan and China. Based on this topic analysis, the technology disclosed can, in operation 304, add the keyword “holiday” to the original query of “golden week.” The user could be asked if they are referring to “golden week” in terms of a holiday or in terms of some other topic. With or without confirmation from the user, the keywords for the search can be extended to provide better results to the user. In the same manner, a user can be asked if a particular domain is an appropriate domain.

Optionally, operation 308 can be implemented to further disambiguate the original search terms “golden week” or the original search terms combined with the extended keyword as “golden week holiday” to further narrow the search that is going to be performed. Disambiguation refers to making the search terms more specific using, for example, external data 310 that can be obtained from other sources. For example, the technology disclosed can (i) identify previous searches and results viewed (clicked on) by the user or by other users that have previously searched “golden week” and/or “golden week holiday” (e.g. popularity results), (ii) obtain information from a personal profile of the user that can help add meaning to the original search, (iii) obtain information about upcoming travel plans that the user might have that can help add meaning to the original search and/or (iv) consider the date and/or time that the initial search was made to help add meaning to the original search.

Regarding the popularity results, an example of popularity could be that a query is for the term “golden week.” When a search is conducted on the Wikipedia domain, a click through rate for the search term “golden week” is the highest for an article about Japanese golden week. This example popularity information indicates that the article about golden week in Japan has the highest popularity for the search term “golden week.” This “high popularity” result can be used to update the search terms or keywords to include “golden week Japan” or “golden week holiday Japan.”

The technology disclosed, might, for example, be able to determine from personal profile information and/or social media information that the user is going to travel to Japan next week, which happens to be the week of “golden week” in Japan. Such disambiguation can assist the technology disclosed to further limit the search to “golden week holiday Japan.” Any disambiguation information that can be obtained can also be used to select which language or languages will be used to translate the original search.

In operation 312 the search terms are translated into one or more languages. As described with reference to FIG. 2, the language or languages for translation can be pre-selected by the user or intelligently selected based on the contents of the original query, as well as any further information obtained from optional operations 304 and/or 308.

The translated search terms are used to perform searches in corresponding domains in operation 314 and operation 318. Again, the technology disclosed can translate into many languages and implement searches in many different domains. For example, without the disambiguation operation 308 the technology disclosed might translate the search “golden week holiday” into both Japanese and Chinese and then perform searches in corresponding domains. Additionally, it is possible to perform a search in a Japanese domain using English, Chinese and Japanese. The Japanese domain need not necessarily be limited to only the Japanese language.

In operation 316 an optional topical analysis can be performed on the results of the search in operation 314. This can be used to identify topical themes of the results and eventually lead to more accurate scoring of the results. For example, results that do not relate to the topic “holiday” can be scored lower than results that focus on a “holiday.” Similarly, in operation 320 an optional topical analysis can be performed on the results of the search in operation 318. After the results from the searches are obtained in operations 314, 318 and the optional topical analysis is performed in operations 316, 320, the technology disclosed will score and rank the results in operation 322. If the topical analysis is performed, the scoring and ranking can use the findings of the topical analysis to assign higher scores to results that are more consistent with the topical analysis. If the topical analysis is not performed, then the results can be scored based on the search terms used to start the search. Additional keywords 324 can be used to assist in the scoring of the results. For example, a database of synonyms and antonyms can be used to evaluate the relevancy of the search results. The scoring and ranking can also use popularity data, personal profile information and/or time, location, date information to evaluate, score and rank the results.

The results are translated back into the original language in operation 326 and then eventually presented to the user in operation 328. As discussed above with reference to FIG. 2, the user may opt to have the results translated to a different language than the original language and the results can be presented to the user in many different ways, including visually or verbally.

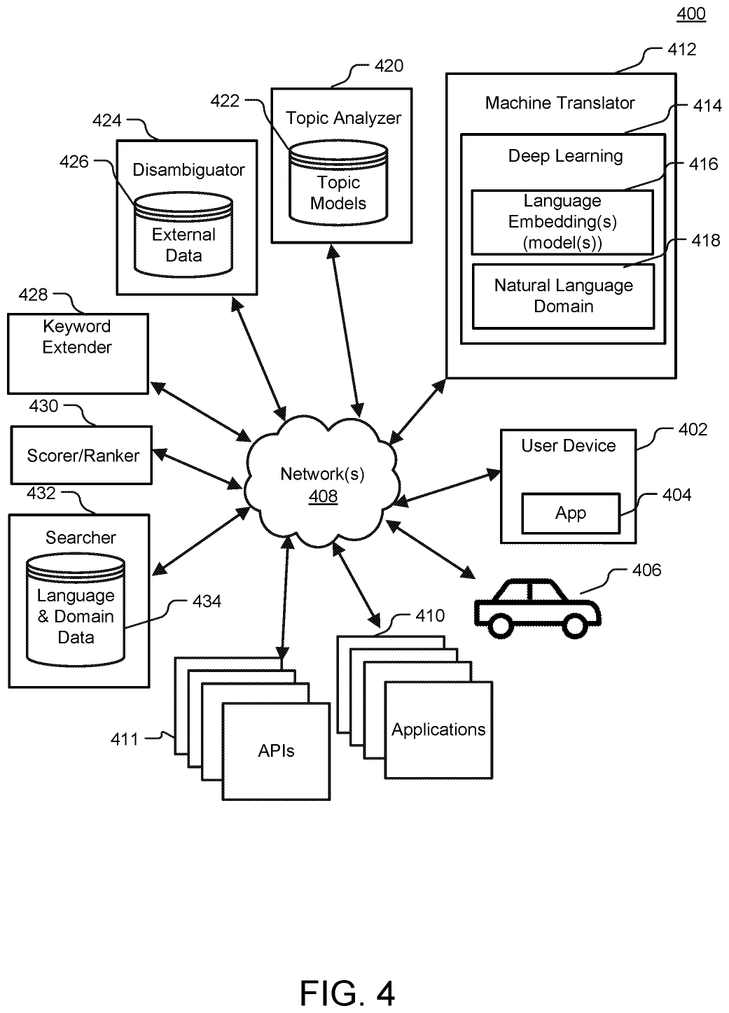

FIG. 4 illustrates an example environment 400 in which a cross-lingual and/or cross-domain search can be implemented by the technology disclosed. The environment 400 includes at least one user device 402, 406. The user device 402 can be a mobile phone, tablet, workstation, desktop computer, laptop or any other type of user device running an application 404. The user device 402 can be an automobile 406 or any other combination of hardware and software that is running an application 404.

The user devices 402, 406 are connected to one or more communication networks 408 that allow for communication between various components of the environment 400 and that allow for performing of searches on the internet or other networks. In one implementation, the communication networks 408 include the internet. The communication networks 408 also can utilize dedicated or private communication links that are not necessarily part of the public internet. In one implementation the communication networks 408 use standard communication technologies, protocols, and/or inter-process communication technologies. The user devices 402, 406 are capable of receiving, for example, a first query in a first language, where the purpose of the query is to perform a search on the internet or a private network. The application 404 is implemented on the user devices 402, 406 to capture the first query, whether it is speech input or text input.

The environment 400 also includes applications 410 that can be preinstalled on the user devices 402, 406 or updated/installed on the user devices 402, 406 over the communications networks 408. Additionally, the environment 400 includes Application Programming Interfaces (APIs) 411 that can also be preinstalled on the user devices 402, 406 or updated/installed on the user devices 402, 406 over the communications networks 408. The APIs 411 can be implemented to allow the user devices 402, 406 and the applications 410 to easily gain access to other components on the environment 400 as well as certain private networks.

The environment 400 also includes a translator 412 that can be running on one or more platforms/servers that are part of a speech recognition system. The translator 412 can be a single computing device (e.g., a server), a cloud computing device, or it can be any combination of computing device, cloud computing devices, etc., that are capable of communicating with each other to perform the various tasks required to perform meaningful translation, as well as speech recognition, if desired. The translator 412 can include a deep learning system 414 that is capable of using artificial intelligence, neural networks, and or machine learning to translate one language into another language. The deep learning 414 can implement language embedding(s), such as a model or models 416 as well as a natural language domain 418 for providing domain-specific translations and interpretations for natural language processing (NLP).

Since the translator 412 can be spread over multiple servers and/or cloud computing device, the operations of the deep learning 414, the language embedding(s) 416 and the natural language domains 418 can also be spread over multiple servers and/or cloud computing device. The applications 410 can be used by and/or in conjunction with the translator 412 to translate spoken input, as well as text input and text file input. Again, the various components of the environment 400 can communicate (exchange data) with each other using customized APIs 411 for security and efficiency.

The translator 412 is capable of translating the first query obtained from the user devices 402, 406 or any other type of user device, from the first language to a second language, to obtain a second query in the second language. The second language can be pre-selected by the user who input the first query, or the second language can be selected based on the content of the first query. The environment 400, via the user devices 402, 406, can also ask the user to select the second language. The translator 412 is not limited to implementing only a second language. The first query can be translated into multiple languages (e.g., second, third, fourth languages, etc.). Virtually, there is no limit on the number of languages that the first query can be translated into.

The user devices 402, 406 and the translator 412 can each include memory for storage of data and software applications, a processor for accessing data in executing applications, and components that facilitate communication over the communications networks 408. The user devices 402, 406 execute applications 404, such as web browsers (e.g., a web browser application 404 executing on the user device 402), to allow developers to prepare and submit applications 410 and allow users to submit speech audio queries (e.g., the speech input 202 of FIG. 2) including natural language utterances and text queries (e.g., the text input 204 and/or the electronic text files 206 of FIG. 2) to be translated by the translator 412.

As mentioned above, the translator 412 can implement one or more language embeddings (models) 416 from a repository of embeddings (models) (not illustrated) that are created and trained using the techniques that are known to a person of ordinary skill in the art. The language embeddings (models) 416 of the translator 412 can create the one or more translations (transcriptions) of the received speech input and/or the received text.

As also mentioned above, the natural language domain 416 can be implemented by the translator 412 in order to add context or real meaning to the translation (e.g., transcription) of the received speech input and/or text input.

The environment 400 can further include a topic analyzer 420 that can implement one or more topic models 422 to analyze, for example, the first query, to determine a topic of the first query that is in the first language. Some of the operations of the topic analyzer 420 are discussed above with reference to FIG. 3 and operation 304 that performs topic analysis using the topic model 306.

Furthermore, the environment 400 can include a disambiguator 424 that is able to utilize any type of external data 426 (e.g., disambiguation information) in order to add further meaning to an obtained query. Some of the operations of the disambiguator 424 are discussed above with reference to FIG. 3 and operation 308 that disambiguates a received query. Essentially, the disambiguator 424 is able to add further meaning to a query by analyzing previous searches of the user, profile data of the user, social data of the user, popularity data of recent searches of the user as well as other internet searches, location information, calendar information, date and time information, etc. For example, the disambiguator 424 can be used to add additional keywords to the initial search that can be helpful to narrow the search to what the user is really wanting to find. The disambiguator 424 can also add additional limits to the search, such as certain dates and/or timeframes (e.g., based on the travel plans of the user additional limits can be added to the original query to identify events that are occurring while the user is traveling to a certain region).

The environment 400 can also include a keyword extender 428 that essentially adds keywords or phrases to the user's query in dependence upon any topics identified by the topic analyzer 420 and/or the disambiguator 424. For example, if the first query in the first language obtained by one of the user devices 402, 406 is “golden week,” the topic analyzer 420 can analyze the first query and determine that the topic is “holiday.” As previously mentioned, golden week is, at least, a Japanese holiday and a Chinese holiday. The disambiguator 424 can use the external data 426 to determine that the user has a vacation scheduled in Japan and that the user has had an increased number of searches for Kyoto, Japan in the last month. Accordingly, the keyword extender 428 can extend the terms of the first query from “golden week” to “golden week holiday Japan.” In other words, the combination of the results obtained by the topic analyzer 420 and the disambiguator 424 can be used by the keyword extender 428 to essentially narrow the scope of the first query by adding additional keywords (e.g., filters). The topic analyzer 420, the disambiguator 424 and the keyword extender 428 can perform the same operations on the second query in the second language as well as other queries translated into other languages. The keyword extender 428 can also use other mechanisms to extend the keywords of the received queries. This can be done by asking the user broad or specific questions regarding their initial query or can simply be done using artificial intelligence or other means to be able to further narrow the initial query.

Regardless of whether the topic analyzer 420, the disambiguator 424 and/or the keyword extender 428 are implemented to change the scope of any of the queries, a searcher 432 of the environment 400 is implemented to perform a first search based on the first query to obtain first language results, to perform a second search based on the second query to obtain second language results, and to perform additional N searches based on N queries to obtain N language results (N being an integer). The searcher 432 can implement language and domain data 434 to determine which domains should be searched using which languages.

The searcher 432 can, for example, identify a first domain for the first query in dependence upon at least one of the first language and the topic of the first query, as determined by the topic analyzer 420. The searcher 432 can, for example, further identify a second domain for the second query in dependence upon at least one of the second language and the topic of the first and/or second query. Turning to the “golden week” example, the searcher 432 may implement a first search in the English language in the domain “wikipedia.org” as “golden week holiday Japan” and implement a second search in the Japanese language in the domain “jp.wikipedia.org” as “golden week holiday Japan.” The searcher 432 is not limited to searching just a single domain in the first language and a single domain in the second languages. The searcher 432 can search multiple domains in each language in parallel or in serial. For example, if an insufficient number of results are found after searching in the first domain in the first language, a second domain may be searched in the first language. The same goes for other domains in other languages.

In an implementation, the topic analyzer 420, the disambiguator 424 and the keyword extender 428 can be implemented to update the contents of the received first query prior to the translation of the first query in the first language to the second query in the second language by the translator 212. Alternatively, the topic analyzer 420, the disambiguator 424 and the keyword extender 428 can be implemented to update the contents of the second query, the third query, etc. after the translator 212 translates the first query into other languages.

In another implementation, the technology disclosed can automatically determine the second language, as well as other languages to translate into, in dependence upon information gathered by the topic analyzer 420, the disambiguator 424 and/or the keyword extender 428.

After search results are obtained from the searcher 432, a scorer/ranker 430 can be implemented to score and rank the results. The topic analyzer 420 can be implemented again to perform a topic analysis on the results. The results can then be filtered to throw out results that are not related to the topic of the queries. For example, the topic analyzer 420 might identify a certain number of results that are related to the Chinese golden week. These results might be thrown out or assigned a low score by the scorer/ranker 430 because the topic of the results is not related to the Japanese golden week. Alternatively, the scorer/ranker 430 can be programmed or modeled to allow a certain amount of exploration into topics that are different from an originally identified topic, while also capitalizing (exploiting) results that are identified to have topics that match the originally identified topic. A person of skill in the art will understand and recognize various exploration-exploitation models that can be implemented to exploit results that are likely to have matching topics as well as exploit other possibilities.

Just like the disambiguator 424, the scorer/ranker 430 can use popularity data or information, personal profile information, social network information, location information, time and date information, etc. to score the results. As previously mentioned with reference to FIGS. 2 and 3, the scorer/ranker 430 can categorically assign scores based on domain(s) and/or language(s) or can score all of the results with respect to each other. Various scoring techniques can be implemented which will be understood by one of ordinary skill in the art. Further, the user may have the option to select various scoring and ranking techniques to be implemented. For example, the user may select to have scoring and ranking independently implemented (and presented) for each language/domain. This would result in the user receiving a score/rank for all of the English results in English domains and receiving a separate score/rank for all of the Japanese results in the Japanese domains. The scorer/ranker 430 may only present the top X results or a top Y percentage of results so as to not overwhelm the user. The values of X and Y can be dependent upon whether the user has submitted a speech input query or a text input query.

After the results are scored and ranked, the results that are in languages other than the first language can be translated back into the first language by the translator 412. After translation, the results can be presented back to the user in various different forms, such as speech output and/or text output. Whether the results are presented in speech or text, the technology disclosed can also provide a brief visual or auditory summary of each result, making it easier for the user to determine which results they would like to view first.

The translator 412, topic analyzer 420, disambiguator 424, keyword extender 428, scorer/ranker 430 and/or the searcher 432 can be implemented using at least one hardware component and can also include firmware, or software running on hardware. Software that is combined with hardware to carry out the actions of the translator 412, topic analyzer 420, disambiguator 424, keyword extender 428, scorer/ranker 430 and/or the searcher 432 can be stored on computer readable media such as rotating or non-rotating memory. The non-rotating memory can be volatile or non-volatile. In this application, computer readable media does not include a transitory electromagnetic signal that is not stored in a memory; computer readable media stores program instructions for execution. The translator 412, topic analyzer 420, disambiguator 424, keyword extender 428, scorer/ranker 430 and/or the searcher 432, as well as the applications 410, the topic models, 422, external data 426, the language and domain data 434 and the APIs 411 can be wholly or partially hosted and/or executed in the cloud or by other entities connected through the communications network 408.

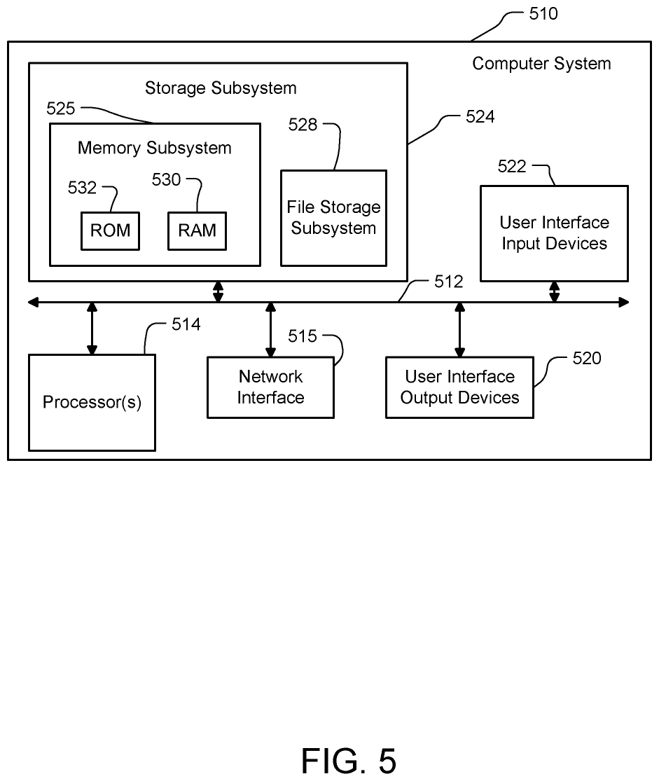

FIG. 5 is a block diagram of an example computer system that can implement various components of the environment 400 of FIG. 4. Computer system 510 typically includes at least one processor 514, which communicates with a number of peripheral devices via bus subsystem 512. These peripheral devices may include a storage subsystem 524, comprising for example memory devices and a file storage subsystem, user interface input devices 522, user interface output devices 520, and a network interface 515. The input and output devices allow user interaction with computer system 510. Network interface 515 provides an interface to outside networks, including an interface to the communication networks 408, and is coupled via the communication networks 408 to corresponding interface devices in other computer systems.

User interface input devices 522 may include a keyboard, pointing devices such as a mouse, trackball, touchpad, or graphics tablet, a scanner, a touchscreen incorporated into the display, audio input devices such as speech recognition systems, microphones, and other types of input devices. In general, use of the term “input device” is intended to include all possible types of devices and ways to input information into computer system 510 or onto communication network 408.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. These software modules are generally executed by processor 514 alone or in combination with other processors.

Memory subsystem 525 used in the storage subsystem can include a number of memories including a main random-access memory (RAM) 530 for storage of instructions and data during program execution and a read only memory (ROM) 532 in which fixed instructions are stored. A file storage subsystem 528 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 528 in the storage subsystem 524, or in other machines accessible by the processor.

Bus subsystem 512 provides a mechanism for letting the various components and subsystems of computer system 510 communicate with each other as intended. Although bus subsystem 512 is shown schematically as a single bus, alternative embodiments of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating the various embodiments. Many other configurations of computer system 510 are possible having more or fewer components than the computer system depicted in FIG. 5.

As used herein, a given event or value is “responsive” to a predecessor event or value if the predecessor event or value influenced the given event or value. If there is an intervening processing element, step or time period, the given event or value can still be “responsive” to the predecessor event or value. If the intervening processing element or step combines more than one event or value, the signal output of the processing element or step is considered “responsive” to each of the event or value inputs. If the given event or value is the same as the predecessor event or value, this is merely a degenerate case in which the given event or value is still considered to be “responsive” to the predecessor event or value. “Dependency” of a given event or value upon another event or value is defined similarly.

### Some Example Use Cases

In an example use case, the technology disclosed will allow the user to use a search engine and a translation filter. As an input, the user will say (or type) in English “cherry blossom event in Kyoto.” The technology disclosed will perform an internet search with user keywords in English (e.g., “cherry blossom event in Kyoto”). The English search will also be translated into Japanese and a search of Japanese content will be performed using the translated search. The technology disclosed will then integrate search results from both the English sources and the Japanese sources and present the results to the user in the users' native language (e.g., English). Note that the results can be presented to the user in a different language if the user so desires.

In another example use case, the technology disclosed will build a custom natural language module for translated language understanding as natural language input. For example, as an input, the user will provide a speech input or a text input in English, while in a Spanish speaking country, “I want to eat lamb or beef.” The technology disclosed an implement a translator or a personal assistant to translate the words “I want to eat lamb or beef” into the language of the local country (e.g., Spanish). The technology disclosed will then search for local restaurants that serve the lamb or beef dishes. The technology disclosed will then compare scores/rating on only these dishes to each other, rather than the overall scores/ratings of the restaurants. Then the technology disclosed can provide, as an output, a dish name in English with an image (when available) as well as restaurant location and overall review to users for selection. The user could then use the technology disclosed to pick a restaurant with the dish, make a reservation, provide directions and/or order the food in the native language.

In a further use case, the user can input in Chinese “ [symbol] ? ” (“handstand”). However, there is no Chinese Wikipedia article for “handstand.” As a result, the technology disclosed will receive input in Chinese, translate the characters to the English word “handstand”, and then search English “wikipedia.org” for “handstand.” The technology disclosed will then extract the first sentence of the top result, “A handstand is the act of supporting the body in a stable, inverted vertical position by balancing on the hands.” The technology disclosed can then translate the extracted first sentence to Chinese, “ [symbol] [symbol] [symbol] [symbol] ” and then give the user a Chinese language output explaining what a handstand is.

### Some Particular Implementations

We describe various implementations of performing a cross-lingual and cross-domain search.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure occasionally reminds the user of these options. Omission from some implementations of recitations that repeat these options should not be taken as limiting the combinations taught in the preceding sections—these recitations are hereby incorporated forward by reference into each of the following implementations.

A method of the technology disclosed performs the cross-lingual search by receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results and presenting, to the user, integrated overall results including at least some of the first language results and some of the translated second results.

In an implementation, the method can perform a topic analysis on the first query to determine a topic of the first query. Additionally, the method may include identifying a first domain for the first query in dependence upon at least one of the first language and the determined topic and identifying a second domain for the second query in dependence upon at least one of the second language and the determined topic.

In an implementation, the user can filter the overall results according to the first domain and the second domain.

In a further implementation, the performing of the topic analysis can further include determining extended keywords to add to the first query in dependence upon the determined topic, and prior to the translating of the first query, updating the first query by adding the extended keywords to the first query. Additionally, in an implementation, the performing of the topic analysis can further include determining additional limits to add to the first query in dependence upon at least one of the determined topic and the extended keywords, and prior to the translating of the first query, further updating the first query by adding the additional limits to the first query.

In another implementation, the method can further include disambiguating the first query using disambiguation information, to obtain at least one of additional keywords and additional limits, and prior to the translating of the first query, further updating the first query by adding, to the first query, the at least one of the additional keywords and the additional limits.

Further, in an implementation, the second language can be automatically determined in dependence upon at least one of the determined topic and an analysis of the first query.

Additionally, in an implementation, the method can include prior to performing the translating of the second language results, scoring the first language results and the second language results, and ranking the first language results and the second language results based on the scoring.

In another implementation, the presenting of the overall results to the user includes providing only a top-ranked portion of the first language results and the second language results.

Furthermore, in an implementation, the method can further include performing a topic analysis on the first language results and the second language results, and the scoring of the first language results and the second language results is performed based on the topic analysis.

The technology disclosed can also be implemented as a system that includes one or more processors coupled to memory. The memory is loaded with computer instructions that cause the system to, when the computer instructions are executed, perform certain actions. Those actions can include receiving a first query in a first language, translating the first query from the first language to a second language, to obtain a second query in the second language, performing a first search based on the first query to obtain first language results, performing a second search based on the second query to obtain second language results, translating the second language results to the first language, to obtain translated second results, and presenting, to the user, integrated overall results including at least some of the first language results and some of the translated second results.

This system implementation and other systems disclosed optionally include one or more of the following features. The system can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

Other implementations may include a non-transitory computer readable storage medium storing instructions executable by a processor to perform functions of the system described above.

Computer readable media (CRM) implementations of the technology disclosed include a non-transitory computer readable storage medium impressed with computer program instructions, when executed on a processor, implement the methods described above.

Each of the features discussed in this particular implementation section for the first system implementation applies equally to the CRM implementation. As indicated above, all the system features are not repeated here and should be considered repeated by reference.

We claim as follows:

1. A method of performing cross-lingual search, the method comprising:
receiving a first query in a first language;
translating the first query from the first language to a second language, to obtain a second query in the second language;
performing a first search based on the first query to obtain first language results;
performing a second search based on the second query to obtain second language results;
translating the second language results to the first language, to obtain translated second results; and
presenting, to a user, integrated overall results including one or more of the first language results and one or more of the translated second results.

2. The method of claim 1, further comprising performing a topic analysis on the first query to determine a topic of the first query.

3. The method of claim 2, further comprising:
identifying a first domain for the first query in dependence upon at least one of the first language and the determined topic; and
identifying a second domain for the second query in dependence upon at least one of the second language and the determined topic.

4. The method of claim 3, wherein the user is able to filter the overall results according to the first domain and the second domain.

5. The method of claim 2, wherein the performing of the topic analysis further includes:
determining extended keywords to add to the first query in dependence upon the determined topic; and
prior to the translating of the first query, updating the first query by adding the extended keywords to the first query.

6. The method of claim 5, wherein the performing of the topic analysis further includes:
determining additional limits to add to the first query in dependence upon at least one of the determined topic and the extended keywords; and
prior to the translating of the first query, further updating the first query by adding the additional limits to the first query.

7. The method of claim 5, further comprising:
disambiguating the first query using disambiguation information, to obtain at least one of additional keywords and additional limits; and
prior to the translating of the first query, further updating the first query by adding, to the first query, the at least one of the additional keywords and the additional limits.

8. The method of claim 2, wherein the second language is automatically determined in dependence upon at least one of the determined topic and an analysis of the first query.

9. The method of claim 1, further comprising:
prior to performing the translating of the second language results, scoring the first language results and the second language results; and
ranking the first language results and the second language results based on the scoring.

10. The method of claim 9, wherein the presenting of the overall results includes providing only a top-ranked portion of the first language results and the second language results.

11. The method of claim 9, wherein:
the method further comprises performing a topic analysis on the first language results and the second language results; and
the scoring of the first language results and the second language results is performed based on the topic analysis.

12. A non-transitory computer-readable recording medium having a computer program for performing a cross-lingual search recorded thereon, the computer program, when executed on a computer including a processor and memory, causing the computer to perform a method comprising:
receiving a first query in a first language;
translating the first query from the first language to a second language, to obtain a second query in the second language;
performing a first search based on the first query to obtain first language results;
performing a second search based on the second query to obtain second language results;
translating the second language results to the first language, to obtain translated second results; and
presenting, to a user, integrated overall results including one or more of the first language results and one or more of the translated second results.

13. The non-transitory computer-readable recording medium of claim 12, further comprising performing a topic analysis on the first query to determine a topic of the first query.

14. The non-transitory computer-readable recording medium of claim 13, further comprising:
identifying a first domain for the first query in dependence upon at least one of the first language and the determined topic; and
identifying a second domain for the second query in dependence upon at least one of the second language and the determined topic.

15. The non-transitory computer-readable recording medium of claim 14, wherein the user is able to filter the overall results according to the first domain and the second domain.

16. The non-transitory computer-readable recording medium of claim 13, wherein the second language is automatically determined in dependence upon at least one of the determined topic and an analysis of the first query.

17. A system including one or more processors coupled to memory, the memory loaded with computer instructions to perform a cross-lingual search, the computer instructions, when executed on the processors, implement actions comprising:
receiving a first query in a first language;
translating the first query from the first language to a second language, to obtain a second query in the second language;
performing a first search based on the first query to obtain first language results;
performing a second search based on the second query to obtain second language results;
translating the second language results to the first language, to obtain translated second results; and
presenting, to a user, integrated overall results including one or more of the first language results and one or more of the translated second results.

18. The system of claim 17, wherein the actions further comprise performing a topic analysis on the first query to determine a topic of the first query.

19. The system of claim 18, further comprising:
identifying a first domain for the first query in dependence upon at least one of the first language and the determined topic; and
identifying a second domain for the second query in dependence upon at least one of the second language and the determined topic.

20. The system of claim 19, wherein the user is able to filter the overall results according to the first domain and the second domain.
